(19) United States
(12) Patent Application Publication
(10) Pub. No.: US 2017/0269454 A1
(43) Pub. Date: Sep. 21, 2017

(54) OPTICAL MODULATOR

(71) Applicant: Chen-Kuo Sun, Escondido, CA (US)

(72) Inventors: Chen-Kuo Sun, Escondido, CA (US); Dingbo Chen, San Diego, CA (US)

(21) Appl. No.: 15/492,262

(22) Filed: Apr. 20, 2017

Related U.S. Application Data
(63) Continuation-in-part of application No. 14/848,707, filed on Sep. 9, 2015.
Application No. 14/848,707 is a continuation-in-part of application No. 14/687,726, filed on Apr. 15, 2015, now Pat. No. 9,500,929.

(51) Int. Cl. G02F 1/313; H01P 11/00

(52) U.S. Cl. CPC G02F 1/3132; G02F 1/3133; H01P 11/003; G02F 2201/06; G02F 2201/12

(57) ABSTRACT

An optical modulator for switching an optical signal of wavelength λ from one waveguide-electrode to another requires that both waveguide-electrodes be made of an electrically conducting material. Also, a non-conducting cross-coupling material fills a slot along a length L between the waveguide-electrodes. Importantly, cross-coupling material in the slot provides a separation distance x_{c} between the waveguide-electrodes that is less than 0.35 microns. When a switching voltage V_{π} is selectively applied to the waveguide-electrodes, a strong uniform electric field E is created within the cross-coupling material. Thus, E modulates the cross-coupling length of the optical signal by an increment ±Δ each time it passes back and forth through the cross-coupling material along the length L. Thus, after an N number of cross-coupling length cycles along the length L, when NΔ equals one cross-coupling length, the optical signal is switched from one waveguide-electrode to the other.

This application is a continuation-in-part of application Ser. No. 14/848,707, filed Sep. 9, 2015, which is currently pending and which is a continuation-in-part of application Ser. No. 14/687,726, filed Apr. 15, 2015, which issued as U.S. Pat. No. 9,500,929 on Nov. 22, 2016. The contents of application Ser. No. 14/848,707 and U.S. Pat. No. 9,500,929 are incorporated herein by reference.

### FIELD OF THE INVENTION

The present invention pertains generally to systems and methods that employ switches and modulators during the transmission of optical signals through optical waveguides. More specifically, the present invention pertains to optical switches and modulators that employ a cross-coupling material which is sandwiched between two waveguides, wherein the waveguides are aligned parallel to each other, and an electric field, E, is used to change the refractive index, n_{c}, of the cross-coupling material to transfer an optical signal from one waveguide to the other. The present invention is particularly, but not exclusively, useful as an electro-optically coupled switch wherein the cross-coupling material is structured as a thin, flat layer, and the electrical field, E, is strong and uniform, with flux lines oriented substantially perpendicular to the entire layer of cross-coupling material and confined between the waveguides.

### BACKGROUND OF THE INVENTION

It is well known that an optical waveguide is a physical structure which guides electromagnetic waves (e.g. light) through the structure. The guidance, or confinement, of light by the waveguide is the result of internal reflections within the waveguide. As a physical event, these internal reflections result when the difference between the refractive index, n_{wg}, of the waveguide material, and that of the surrounding environment, nₒ, has a certain value. Otherwise, there may be no confinement, or inefficient confinement, of light within the waveguide.

It is also well known that an applied electric field can change the refractive index of a material through a linear or nonlinear electro-optic effect such as the well-known Pockels' effect (linear) or the Kerr effect (nonlinear). In particular, the Pockels' electro-optic effect is a case wherein the influence of a voltage that is applied across a material will change the index of refraction, n, of the material by an amount, Δn, which can be mathematically expressed as:

Δn=−rn³E/2

where r is the Pockels' constant, and E is the strength of the electric field.

In the context of a planar, waveguide coupler switch, an electric field E is applied between two cross-coupled optical waveguides which are separated by an electro-optic material having a refractive index, nₑₒ. When applied, the electric field, E, changes the refractive index, nₑₒ, of the cross-coupling material to modify the cross-coupling characteristics between the two optical waveguides. As a result, light traveling along one waveguide is moved to the other waveguide.

With the above in mind, the design of a vertical, waveguide optical switch as envisioned for the present invention involves several interactive factors of particular importance. These include: the separation distance, d, between the waveguides (i.e. the thickness of the cross-coupling material); the refractive index of the cross-coupling material, n_{c}, (also sometimes referred to herein as nₑₒ); and the design (i.e. configuration) of the electric field E.

In particular, insofar as the design of the electric field is concerned, the ability of the device (i.e. electro-optic switch) to configure and confine the electric field, E, relative to the cross-coupling material is of paramount importance. Specifically, the concern here for a design of the electric field, E, is three-fold. First: the electric field, E, passing through the cross-coupling material should be uniform (i.e. the electric field flux lines are parallel to each other). Second: flux lines of the electric field, E, should be confined to the cross-coupling material. And third: the flux lines of the electric field, E, should be aligned with the polarization direction of the cross-coupling material (i.e. perpendicular to the light beam pathway in the waveguides). The purpose for harmonizing these factors is to optimize the electro-optic modulation efficiency of the device.

In another aspect of the present invention, the structure of an electro-optically coupled switch (modulator) is considered for the purpose of operationally accommodating an optical signal. The object here is to optimize the orientation of the optical signal's electric field for transit of the optical signal through the cross-coupling material between waveguides. This requires that the orientation established by the electro-optic coefficient of the cross-coupling material be substantially parallel (i.e. in the same direction), or nearly so, to the optical signal's electric field.

It is known that a laser beam (i.e. optical signal) will have both an electric field and a magnetic field that are oriented in mutually orthogonal planes. A consequence of this is that a waveguide will impose conditions on the optical signal which will cause it to exhibit transverse modes. In particular, these modes are either a TM (Transverse Magnetic) mode wherein the electric field is vertical and the magnetic field is horizontal; or a TE (Transverse Electric) mode wherein the electric field is horizontal and the magnetic field is vertical. It is also known that an electro-optic cross-coupling material, positioned between two waveguides, will exhibit a unique polarizing plane that is most responsive to the electric field of an optical signal passing through the cross-coupling material.

Thus, the orientation of a response plane in a cross-coupling material is important insofar as an alignment of this response plane with the flux lines of an externally applied electric field, E, is concerned. For disclosure purposes, it is noted that the electro-optic coefficient of a waveguide material is indicative of the response plane's orientation in the cross-coupling material.

In cases where a polymer is used as the cross-coupling material, it is known that the orientation of the response plane in the polymer that is established by its electro-optic coefficient can be influenced by a process commonly referred to as “poling” (i.e. it can be changed, at least to some extent). For other materials, however, the electro-optic coefficient and the resultant orientation of its response plane may be a fixed characteristic of the material. In any event, regardless whether the waveguide is made of a polymer, a SiON/silica material or some other material well known in the pertinent art, the electro-optic coefficient is an important consideration.

With the above in mind, the interaction between the electro-optic coefficient orientation in the cross-coupling material, and the electric field of an optical signal as it passes through the cross-coupling material between waveguides (e.g. TM mode), needs to be somehow accounted for. For this purpose, in order to optimize the electro-optic modulation efficiency of a switching device (modulator), it is necessary to have the response plane of the cross-coupling material aligned as nearly parallel to the externally applied electric field, E, in the cross-coupling material as possible. To do this, the electro-optic coefficient orientation in the cross-coupling material should be aligned parallel with the flux lines of the externally applied electric field, as nearly as possible.

As examples of applications involving the above, first consider the case where a polymer is used as the cross-coupling material. In this case, the orientation of the electro-optic coefficient of the cross-coupling material relative to the flux lines of the applied electric field, E, are preferably parallel to each other (e.g. TM mode). On the other hand, in most quantum well cases, the externally applied electric field, E, is perpendicular to the electro-optic coefficient of the cross-coupling material (e.g. TE mode). Thus, in these examples, it is preferable for the externally applied electric field and the electro-optic coefficient to have different alignment orientations.

Another phenomenon that occurs when an optical signal passes through a cross-coupling material, from one waveguide to another, is that the axial cross-coupling distance traveled by the optical signal through the cross-coupling material is incrementally changed. This change is a function of the applied electric field, E, and the incremental change Δ may be either plus or minus. Moreover, the incremental change Δ occurs each time the optical signal passes through the cross-coupling material. Importantly, these changes are cumulative.

In light of the above, it is an object of the present invention to provide an electro-optically coupled switch having a cross-coupling material with a refractive index, n_{c}, that ensures good optical confinement between two waveguides. Another object of the present invention is to provide an electro-optically coupled switch with a cross-coupling material having a refractive index, n_{c}, that establishes a strong electro-optic modulation coefficient. Yet another object of the present invention is to design the structure for an electro-optic switch having the proper waveguide separation to achieve strong waveguide cross-coupling; while maximizing the electro-optic efficiency of the device by providing good optical confinement in the cross-coupling material that facilitates the transfer of light into or out of the waveguide. Yet another object of the present invention is to have the response plane of the cross-coupling material (determined by the electro-optic coefficient of the cross-coupling material) aligned as nearly parallel as possible to the flux lines of the externally applied electric field, E, to thereby optimize electro-optic modulation efficiency of the device. Still another object of the present invention is to provide a multi-step procedure for the manufacture of the electro-optically coupled switch. Another object of the present invention is to provide an electro-optically coupled switch wherein a uniform electric field, E, is confined and directed through a layer of cross-coupling material that is sandwiched between two optical waveguides, and wherein the electric field intensity is normal to the layer of cross-coupling material. It is also an object of the present invention to provide an electro-optically coupled switch (modulator) that uses cumulative, incremental changes Δ in the distance traveled by an optical signal through a cross-coupling material to direct the optical signal from one waveguide to another. Still another object of the present invention is to provide an electro-optically coupled switch that is simple to manufacture, is easy to use and is comparatively cost effective.

### SUMMARY OF THE INVENTION

In accordance with the present invention, a vertical electro-optically coupled switch includes first and second waveguides, with a layer of cross-coupling material positioned between the waveguides. In combination, the first and second waveguides, together with the cross-coupling material located therebetween, create what is sometimes hereinafter referred to as a waveguide stack. In any event, an electric field, E, is established through the cross-coupling material. Variations in E can then be made (i.e. a switching voltage, V_{π}) to change the refractive index of the cross-coupling material, n_{c} (i.e. n_{c}≡nₑₒ). The intended result here is to transfer the transmission of an optical signal, λ, from one waveguide to the other. Several structural aspects of the cross-coupling material, as well as functional aspects, of the electric field, E, are particularly important.

For purposes of the present invention, the layer of cross-coupling material should have a depth, d, and it should be coextensive with the length, L, of the waveguides. As envisioned for the present invention, the refractive index of a first waveguide, n_{wg1}, will be equal to, or nearly equal to, the refractive index of a second waveguide, n_{wg2} (i.e. n_{wg1}≈n_{wg2}). Typically, the distance, d, between waveguides will be smaller than the value of λ/n_{wg} (i.e. d<λ/n_{wg}). Further, the waveguide width, W, is optimized to improve optical confinement and to reduce optical loss.

With regard to the electric field, E, as noted above it must be strong and uniform. Further, flux lines of the electric field, E, are to be oriented substantially perpendicular to the layer of cross-coupling material that is positioned between the waveguides. Furthermore, the electric field, E, is to be confined between the waveguides across the entire layer of the cross-coupling material. To do this a filler material having a refractive index, n_{f}, is positioned against the cross-coupling material between the waveguides.

For a construction of the present invention, the depth, d, of the cross-coupling material, the length, L, of the waveguides, and the refractive indexes n_{wg1}, n_{wg2}, and n_{c}, as well as the field strength for E, all need to be selected and based upon the wavelength, λ, of the optical signal that is being transmitted. As envisioned for the present invention, the cross-coupling material may be a polymer, when the first and second waveguides are also polymers. The cross-coupling material may also be a polymer when the waveguides are a SiON/silica material. On the other hand, if the waveguides are doped materials then, depending on the doping used, the cross-coupling material can either be a polymer, a PIN planar-diode-structure semiconductor, or a PIN multiple-quantum-well semiconductor.

A voltage source is connected to the waveguide stack for selectively establishing a uniform electric field, E, through the cross-coupling material. Preferably, the electric field, E, is confined in the cross-coupling material by a filler material which encloses the cross-coupling material between the first waveguide and the second waveguide. Furthermore, and most importantly, the electric field, E, is oriented everywhere across the cross-coupling material, perpendicular to the layer of cross-coupling material.

Incorporated with the voltage source is an electric switch. Specifically, this switch is a means for imposing a switching voltage, V_{π}, to the waveguide stack. In particular, the switching voltage, V_{π}, is used to selectively change the refractive index, n_{c}, of the cross-coupling material.

In a preferred embodiment of a waveguide stack for the present invention, the first waveguide and the second waveguide are made of a SiON/silica material, and the cross-coupling material is a polymer. For this embodiment, the means for imposing V_{π} on the waveguide stack includes a first transparent electrical contact that is connected with the voltage source and is positioned between the first waveguide and the cross-coupling material. A second transparent electrical contact which is connected with the voltage source and positioned between the second waveguide and the cross-coupling material is also included. In a variation of the preferred embodiment, the first waveguide, the second waveguide and the cross-coupling material can all be made of a polymer.

In a first alternate embodiment of the present invention, the first waveguide and the second waveguide are each made of a same, lightly-doped, electrically-conductive material, and the waveguides are individually positioned in contact with the voltage source. Specifically, both the first waveguide and the second waveguide are N doped. The means for imposing the switching voltage, V_{π}, to the waveguide stack will then include a first N⁺ doped layer that is positioned in electrical contact between the first N doped waveguide and the voltage source. Similarly, a second N⁺ doped layer is positioned in electrical contact between the second N doped waveguide and the voltage source. For this embodiment of the present invention the cross-coupling material is preferably a polymer.

In a second alternate embodiment of the present invention, the first waveguide is P doped and the second waveguide is N doped. In this case, the means for imposing V^{π} to the waveguide stack includes a first P⁺ doped layer positioned in electrical contact between the first P doped waveguide and the voltage source. Also, a second N⁺ doped layer is positioned in electrical contact between the second N doped waveguide and the voltage source. For this second alternate embodiment the cross-coupling material can be either a PIN planar-diode-structure semiconductor, or a PIN multiple-quantum-well semiconductor.

For an operation of the present invention, the switch can include a first input port at the upstream end of the first waveguide, and a first output port at the downstream end of the first waveguide. Also, the switch can include a second output port at the downstream end of the second waveguide. With this arrangement, when an incoming optical signal, λ, is received at the first input port it can be selectively routed to the second output port by the switching voltage, V_{π}. As an additional feature of the present invention, a second input port can be used at the upstream end of the second waveguide. In this case, when an incoming optical signal, λ′, is received at the second input port, it can be selectively routed to the first output port by the switching voltage, V_{π}.

A method for manufacturing an electro-optically coupled switch in accordance with the present invention requires the creation of a base member. In detail, the base member will preferably be a rectangular shaped block having a length L, a width Wₛ, and a thickness T. Also, the base member defines a central plane that is located equidistant between opposed edges and along the length L of the base member. For its construction, the base member includes a semiconductor substrate and a layer of a lightly doped semiconductor material, with a layer of an insulator material positioned between the semiconductor substrate and the semiconductor layer.

For the manufacture of the switch in accordance with the present invention, a first mask is initially used to perform a first etch on the semiconductor layer. Structurally, the first mask is formed with a central cutout and a pair of rectangular shaped side cutouts which are positioned on opposite sides of the central cutout from each other. Together, the central cutout and the side cutouts establish a pair of parallel strips. Dimensionally, each strip will have the length L and a same width x_{w}, with a distance x_{c} between them.

In use, the first mask is aligned to cover the semiconductor layer of the base member, with the parallel strips symmetrically positioned to straddle the central plane. With the first mask in place, the first etch is performed to remove material from the layer of semiconductor material in three different areas. In detail, one area extends along the length L and through a distance x_{c} symmetrically centered on the central plane. The other two areas straddle the first area at the distance x_{w} from the first area. In these two areas, etching is done along the length L and through a distance xₑ that extends from each edge of the base member toward the central plane. In all three areas, etching is done to a same depth d₁.

Next, a second mask is used to further etch the base member. In detail, the second mask is formed with a single rectangular shaped cutout having a length L and a width W_{c} (where x_{c}+2x_{w}>W_{c}>x_{c}). In use, the second mask is aligned to cover the base member with the rectangular shaped cutout symmetrically positioned relative to the central plane. A second etch is then performed to remove material from the layer of semiconductor material on the base member to a depth d₂ along the length L and through the distance x_{c}. This etch effectively creates a slot which exposes the insulator material in the slot between opposed waveguides created by the first and second etches. As intended for the present invention, each waveguide will have a width of at least x_{w} and a length L. With regard to the first and second etches, dimensional considerations show d₂>d₁, and Wₛ=2xₑ+2x_{w}+x_{c}.

A third mask is then used for a heavy semiconductor doping between each waveguide and its final metal contact to reduce switch series resistance. Specifically, the third mask is essentially a panel having a length L and a width equal to Wₛ−2x_{d}. In use, the third mask is symmetrically aligned on the base member to expose edge segments of the base member, wherein each edge segment has a width x_{d} (where x_{d}<xₑ) and is at a respectively same distance from the slot. The third mask is then used to define the area for depositing heavy semiconductor dopants into the layer of semiconductor material. This depositing is done throughout the exposed layer of semiconductor material behind the mask and above the insulator material of the base member in the edge segments.

Once the first and second etches, and the doping process have been performed, a heavily doped semiconductor material has been prepared on top of the insulator material in the edge segments to create respective contact pads. In this case, the heavily doped semiconductor material that is used for the contact pads is preferably N⁺ doped and the layer of semiconductor waveguide is preferably lightly N doped. Electrodes are then connected with each contact pad. Further, the slot between the waveguides is filled with a polymer material, and, if needed, the polymer material in the slot is poled to establish an operational electro-optic coefficient for the cross-coupling material in the slot.

As envisioned for the present invention, the first mask, the second mask, and the third mask are each made using a photo-lithography process. Further, the first etch, the second etch, and the heavy dopant deposition are each accomplished using a chemical/physical process well known in the pertinent art.

In another aspect of the present invention, the switching of an optical signal from one waveguide to another is considered from the perspective of the wave path that is followed by the optical signal. When a single waveguide is considered, by itself, the wave path of the optical signal in the waveguide will be a line that essentially follows along the centerline axis of the waveguide. On the other hand, when two waveguides are optically connected in a side-by-side relationship, the wave path of an optical signal will cross back and forth from one waveguide to the other through a cross-coupling material.

For the present invention, the two waveguides of the optical modulator are made of a conducting semiconductor. Thus, they effectively function as waveguide-electrodes and, in combination, they have a same, predetermined, common length L. Depending on the cross-coupling material that is used to connect the waveguide-electrodes to each other, the wave path of an optical signal as it travels back and forth through the cross-coupling material can be modulated by an electric field E. In this context, when a non-conducting, electro-optical material is used for the cross-coupling material, both its electrical and its optical properties give rise to important considerations.

For a switching operation, the interrelationship between the electrical and optical properties of a cross-coupling material is a function of its index of refraction n, which is mathematically expressed as:

n=nₒ−½nₒ³rE

In the above expression; nₒ is a base value for the index of refraction, r is the electro-optical coefficient for n, and E is the electric field in the cross-coupling material. Functionally, the index n decreases when the electric field E is aligned with r, and it increases when E is in the opposite direction to r.

In accordance with the above expression, n can be controlled electrically by a switching voltage V_{π} which will selectively vary E in the cross-coupling material. Specifically, under the influence of a switching voltage V_{π} the electric field E will have a value equal to V_{π}/x_{c}, and the optical modulator will have a switching performance V_{π}L. In this case, x_{c} is the slot width or separation distance that is established by the cross-coupling material between the waveguide-electrodes. In the event, whenever V_{π} is applied, E will change, and the index of refraction n will also change by a value equal to ±½nₒ³rE. As indicated above, the direction of change caused by V_{π} will depend on the reference direction of the electric field E in its relationship to r.

The optical consequence of the above disclosure is that the cross-coupling length L_{c} for the wave path of an optical signal as it transits through the cross coupling material from one waveguide-electrode to the other, can be modulated by proportional changes of the index n. Specifically, L_{c} can be modulated by an increment ±Δ to a modulated cross-coupling length L_{c}′ (where L_{c}′=L_{c}±Δ), and the sign for ±will depend on the reference direction of E in its relationship to r. In this relationship it is important to note that both an unmodulated cross-coupling length L_{c} and a modulated cross-coupling length L_{c}′ are nearly equal to each other, and both are much greater than Δ (i.e. L_{c}˜L_{c}′>>Δ).

As noted above, it happens when an optical signal passes back and forth through a cross-coupling material, the incremental changes Δ to cross-coupling length L_{c} that result with each pass are cumulative. Of special interest here is the axially-directed length L between the two waveguide-electrodes. In particular, L can be established so that after an N number of cross-coupling length cycles, the optical signal reaches a point where NΔ=L_{c}′. When this condition is satisfied, and the optical signal has traveled the distance L, if the waveguides are separated from each other at that point, no further cross-coupling length modulation is possible and the optical signal will switch from one waveguide to the other. For the present invention, the length L for each waveguide-electrode will typically be in a range between 0.5 mm and 5 mm and the cross-coupling length L_{c} will be in a range between 0.5 μm and 5 μm.

The present invention also recognizes that for an efficient switching operation, the structure for optimal performance requires a balance of several different considerations. In detail, these considerations include factors affecting both the waveguide-electrodes and the cross-coupling material.

Insofar as the waveguide-electrodes are concerned, they must be made of a conducting semiconductor material, such as an N-doped silicon. Preferably, they are constructed as two optical rib waveguides with a size well-known in the art and a slot width x_{c} between them so they will function individually as respective waveguide-electrodes. In this combination, the waveguide-electrodes are oriented in a side-by-side alignment along the length L, and they are positioned in direct and intimate contact with the cross-coupling material that fills the slot.

With the above structure in mind, the novelty of the present invention involves a combination of structural and functional considerations. In particular, sub-volt switching within a length L that approximates a millimeter is uniquely achieved by a combination of factors. For the present invention, the use of cross-coupling waveguide-electrodes with a small slot width x_{c} between them (e.g. x_{c} less than 0.35 μm) is essential. Specifically, these structural aspects of an optical modulator induce a strongly confined index-modulation electric field E within the cross-coupling material in the slot (E=V_{π}/x_{c}). The resulting strong electric field E produces a large change in the index n and a corresponding change in the cross-coupling length L_{c} as disclosed above.

Functionally, a change of the index n in the cross-coupling material by the electric field E is further enhanced by optimizing an optical slot confinement factor Γ when x_{c} is small. Preferably, x_{c} will be less than 0.35 μm and remain essentially within a range between 0.4 μm and 0.04 μm along the common length L of the slot between the waveguide-electrodes. In detail, the confinement factor Γ is related to the switching performance V_{π}L of the optical modulator, which is proportional to x_{c}/Γ. In this relationship, Γ is a measure of how much the intensity of an optical signal is concentrated within the cross-coupling material. With a small x_{c}, a strong confinement factor Γ can be achieved (e.g. Γ>0.15). Also, it is important that under such circumstances an ultra-short cross-coupling length L_{c} is observed. Specifically, L_{c} is typically reduced from a length traditionally much longer than the wavelength of the optical signal λ, to a length in the approximation of λ (e.g. L_{c}′<2λ).

As noted above, the switching performance V_{π}L is proportional to x_{c}/Γ. Thus, in this disclosure, a combination of the small width x_{c} and the strong optical slot confinement factor Γ, a sub-volt-mm V_{π}L product is achieved. Further, the cross-coupling modulation efficiency is proportional to the change of index n calculated by nₒ³rE/2. Thus, the cross-coupling material (e.g. polymer) should have a large electro-optical coefficient r that is greater than 20 μm/V.

The primary purpose for the structural/functional, dimensions/parameters set forth above for components of the optical switch of the present invention is to establish a strong, uniform electric field E, in the cross-coupling material, as well as to minimize x_{c}/Γ along the length L of the optical modulator (switch). Consequently, when V_{π} is applied, although the modulated cross-coupling length L_{c}′ will be nearly equal to the unmodulated cross-coupling length L_{c}, an increment ±Δ occurs between L_{c} and L_{c}′ which is cumulative. Thus, it happens that after an N number of cross-coupling length cycles have been completed through an arbitrary length L along the waveguide-electrodes, L=NL_{c}=(N±1)L_{c}′. Also, as noted above, when NΔ=L_{c}′˜λ, an optical signal can be most efficiently switched from one waveguide-electrode to the other waveguide-electrode.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective-schematic view of a system for transmitting optical signals, which includes an electro-optically coupled switch in accordance with the present invention;

FIG. 2 is a cross-section view of an embodiment of the electro-optically coupled switch for the present invention as seen along the line 2-2 in FIG. 1;

FIG. 3 is a cross-section view of an exemplary switch in accordance with the present invention, as seen along the line 3-3 in FIG. 1, showing the switch/modulation functionality of the present invention;

FIG. 4 is a cross-section view of another embodiment of the electro-optically coupled switch for the present invention as seen along the line 4-4 in FIG. 1;

FIG. 5 is a cross-section view of still another embodiment of the electro-optically coupled switch for the present invention as seen along the line 5-5 in FIG. 1;

FIG. 6 is a perspective view of a work piece used for a manufacture of the electro-optically coupled switch of the present invention;

FIG. 7A is a cross-section of the work piece as seen along the line 7-7 in FIG. 6, with the work piece in an intermediate configuration during a manufacturing process;

FIG. 7B is a view of the work piece as seen in FIG. 7A after manufacture and ready for subsequent assembly in an operational switch;

FIG. 8 is a sequence of evolving cross-sections of the work piece as seen in FIGS. 7A and 7B, with the sequence showing eight different manufacturing steps, respectively numbered (1) through (8), in a manufacture of the present invention;

FIG. 9A is a top plan view of a first mask for use in the manufacture of the present invention;

FIG. 9B is a top plan view of a second mask for use in the manufacture of the present invention;

FIG. 9C is a top plan view of a third mask for use in the manufacture of the present invention;

FIG. 10 shows representative modulated and unmodulated wave paths for an optical signal with comparative changes in the respective cross-coupling lengths of the optical signal during one cycle in accordance with the present invention;

FIG. 11A is a cross-section view of the waveguides for an optical modulator of the present invention as seen in FIG. 3 showing the progress of an optical signal along a length L of the waveguides when the cross-coupling switching voltage V_{π} equals zero or a base value V_{base}, and no switching action is in progress;

FIG. 11B is the cross-section view of the optical modulator shown in FIG. 11A when a switching voltage V_{π} is applied during a switching operation in accordance with the present invention; and

FIG. 12 is a cross-section view of the waveguides as seen along the line 12-12 in FIG. 11A.

### DESCRIPTION OF THE PREFERRED EMBODIMENTS

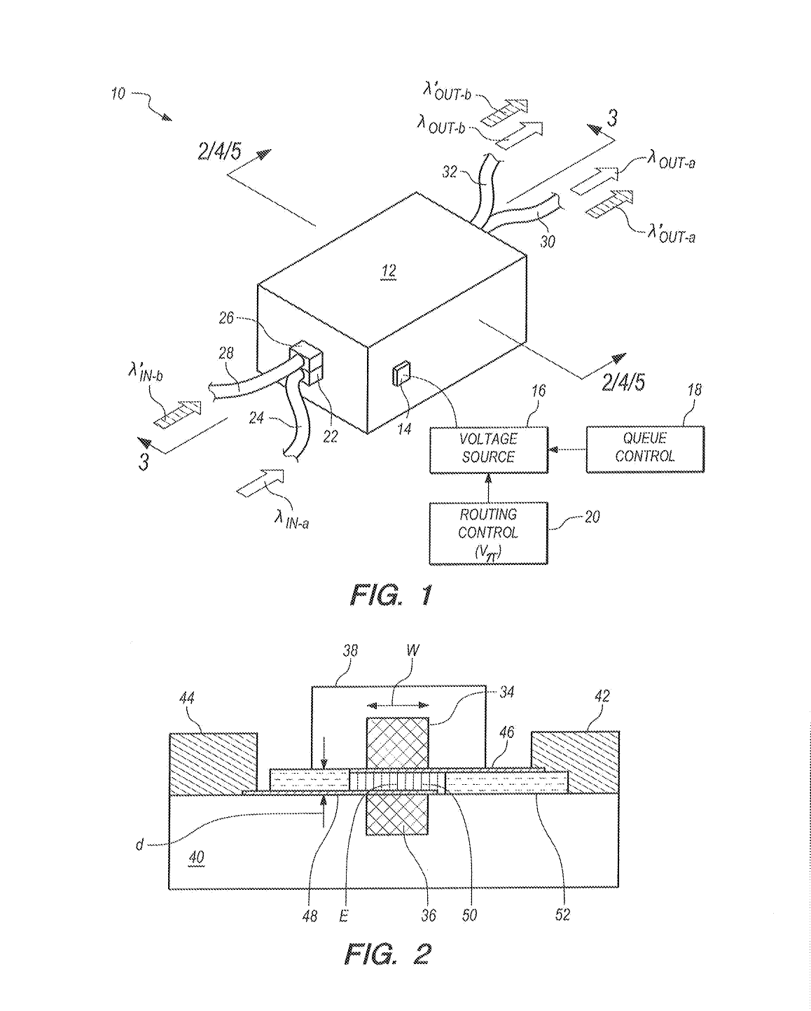

Referring initially to FIG. 1, an electro-optically coupled switch in accordance with the present invention is shown and is generally designated 10. As shown, the switch 10 includes an enclosure 12 for holding and protecting the electro-optic components of the switch 10. Also, an access connector 14 is provided for connecting the electro-optic components (not shown in FIG. 1) with an external voltage source 16. A queue control 18 and a routing control 20 are incorporated with the voltage source 16 to respectively provide for the sequencing, routing and modulation of optical signals, λ, as they pass through the electro-optically coupled switch 10.

Still referring to FIG. 1, it will be seen that the enclosure 12 includes an input port 22 for optically connecting an optical waveguide 24 with the switch 10. Similarly, an input port 26 is provided by the enclosure 12 for optically connecting an optical waveguide 28 with the switch 10. It is to be appreciated that the optical waveguides 30 and 32 will have similar connections with the enclosure 12.

In FIG. 2 the internal, electro-optic components for a preferred embodiment of the switch 10 are shown. There it will be seen that the switch 10 includes a waveguide 34 and a waveguide 36 that are respectively protected by a cladding 38 and a cladding 40. In more detail, each waveguide 34 and 36 has a width, W, and a length, L, and they are vertically aligned in parallel with each other. Further, as shown, the switch 10 includes a metal connector 42 (e.g. +V) and a metal connector 44 (e.g. −V) which are respectively connected with a transparent electrical contact 46 and a transparent electrical contact 48. Further, a cross-coupling material 50 is positioned between the transparent electrical contacts 46 and 48. In accordance with the present invention, the transparent electrical contacts 46 and 48 are in direct contact with the cross-coupling material 50, and are everywhere separated from each other by a distance, d. Further, the transparent electrical contacts 46 and 48 are positioned opposite each other from the cross-coupling material 50. And, they are each positioned between the cross-coupling material 50 and a respective waveguide 34 and 36. Additionally, a filler material 52 is provided to electrically confine the cross-coupling material 50 between the transparent electrical contacts 46 and 48.

Within the combination of components for the switch 10 shown in FIG. 2, the differences in the refractive index of the various materials used are important. In detail, the refractive index of waveguide 34 (a first waveguide), n_{wg1}, will be equal to, or nearly equal to, the refractive index of waveguide 36 (a second waveguide), n_{wg2}. For purposes of the present invention, the refractive indexes of the waveguides 34 and 36 will be the same, or nearly the same, n_{wg1}≈n_{wg2}. Importantly, however, the refractive index of the cross-coupling material 50, n_{c}, (also sometimes noted herein as nₑₒ) needs to be much greater than the respective indexes n_{wg1} and n_{wg2} of the first and second waveguides 34 and 36 (i.e. n_{wg1}<<n_{c}>>n_{wg2}). As noted above, this arrangement is made to achieve strong waveguide cross-coupling, good optical confinement in the cross-coupling material, and efficient electro-optic modulation, with a proper waveguide separation distance, d. For example, n_{c}=1.7, n_{wg}=1.57, and d=0.5 μm. Also, the refractive index of the filler material 52, n_{f}, needs to be smaller than all of the others (i.e. n_{c}>>n_{wg(1 and 2)}>n_{f}, and n_{wg1}≈n_{wg2}).

As shown, the metal connector 42 and the metal connector 44 are separately connected with the voltage source 16. Thus, a +V can be provided to the metal connector 42 by the voltage source 16, and a −V can be provided to the metal connector 44. The result is that a switching voltage, ΔV_{π}, can be applied through the cross-coupling material 50 that will change its refractive index, n_{c}. As envisioned for the present invention, the cross-coupling material 50 may be a polymer, when the waveguides 34 and 36 are also polymers, or when the waveguides 34 and 36 are made of a SiON/silica material.

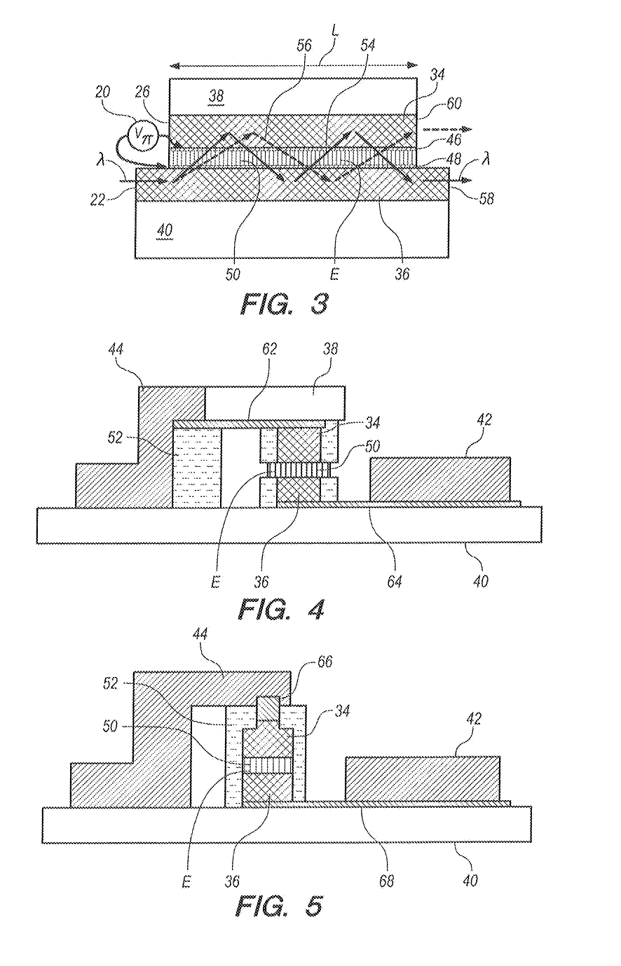

An operation of the switch 10 will be best appreciated with reference to FIG. 3. There it will be seen that, depending on the influence of the switching voltage, V_{π}, an optical signal, λ, can be directed either onto a pathway 54 (solid arrows) or a pathway 56 (dashed arrows). The consequence of this is that, the switching voltage, V_{π}, can be used to guide an optical signal, λ, which enters the switch 10 through the input port 22 to exit the switch 10 from either the output port 58 of waveguide 36 or the output port 60 of waveguide 34.

With the above in mind, and by returning to FIG. 1, it will be appreciated that the routing control 20 can influence the voltage source 16 to selectively establish the switching voltage, V_{π}, and thereby generate the electrical field, E. Importantly, the electrical field, E, when generated, is uniform with the flux lines of the field oriented substantially perpendicular to the length, L, of the waveguides 34 and 36. As mentioned above, the purpose here is to influence the transit of an optical signal, λ, through the switch 10.

For an exemplary operation of the switch 10, refer back to FIG. 1. In this example, consider an optical signal, λᵢₙ₋ₐ, as input from optical waveguide 24, into the waveguide 36 via input port 22. Also consider an optical signal, λ′_{in-b}, as input from optical waveguide 28, into the waveguide 34 via input port 26. For purposes of this example, subscript “a” pertains to waveguide 36, while subscript “b” pertains to waveguide 34.

With cross-reference between FIG. 1 and FIG. 3, and first considering only the optical signal, λ, it is to be appreciated that with no switching voltage, V_{π}, there is no electric field, E, through the cross-coupling material 50. Accordingly, optical signal, λᵢₙ₋ₐ, in optical waveguide 24 will enter switch 10 via input port 22, transit switch 10 on pathway 54, and exit from switch 10 via the output port 58 (FIG. 3) and into the optical waveguide 30 as optical signal, λₒᵤₜ₋ₐ. On the other hand, with a switching voltage, V_{π}, imposed on the cross-coupling material 50, an electric field, E, is generated through the cross-coupling material 50 to change the refractive index, n_{c} (nₑₒ), of the cross-coupling material 50. In this case, the optical signal, λᵢₙ₋ₐ, will transit switch 10 on pathway 56, and exit from switch 10 via the output port 60 (FIG. 3), and into the optical waveguide 32 as optical signal, λ_{out-b}.

Similarly, when considering the optical signal, λ′, it is to be appreciated that with no switching voltage, V_{π}, optical signal, λ′_{in-b}, will enter switch 10 from optical waveguide 28 via input port 26. Optical signal, λ′_{in-b}, will then transit switch 10 and exit via the output port 60 (FIG. 3) and into the optical waveguide 32 as optical signal, λ′_{out-b}. With a switching voltage, V_{π}, imposed on the cross-coupling material 50, however, the optical signal, λ′_{in-b}, will transit switch 10 to exit from switch 10 via the output port 58 (FIG. 3), and into the optical waveguide 30 as optical signal λ′ₒᵤₜ₋ₐ.

Still referring to FIG. 1 it is to be appreciated that the switch 10 can be used either as a switch or as a modulator. Further, it will be appreciated that the queue control 18 can be used as a gate to provide for alternating or sequential access of the optical signals, λ and λ′, to the switch 10. As will be appreciated by the skilled artisan, when switch 10 is used as a modulator, only one continuous wave (CW) light input port 22 and one optical output port (e.g. output port 58, FIG. 3) are required.

FIG. 4 shows an alternate embodiment for the present invention wherein the waveguide 34 and the waveguide 36 are each made of a same, lightly-doped, electrically-conductive material. As shown, the waveguides 34 and 36 are individually positioned in contact with the voltage source 16. For one alternate embodiment of the present invention, both the waveguide 34 and the waveguide 36 are N doped. Accordingly, the means for imposing the switching voltage, V_{π}, includes an N⁺ doped layer 62 that is positioned in electrical contact between the N doped waveguide 34 and the metal connector 44. Similarly, an N⁺ doped layer 64 is positioned in electrical contact between the N doped waveguide 36 and the metal connector 42. Preferably, for this alternate embodiment of the present invention, the cross-coupling material 50 is a polymer.

FIG. 5 shows another alternate embodiment of the present invention wherein the waveguide 34 is P doped and the waveguide 36 is N doped. In this case, the means for imposing V_{π} includes a P⁺ doped layer 66 positioned in electrical contact between the P doped waveguide 34 and the metal connector 44. Also included is an N⁺ doped layer 68 which is positioned in electrical contact between the N doped waveguide 36 and the metal connector 42. In this case, the cross-coupling material 50 can be either a PIN planar-diode-structure semiconductor, or a PIN multiple-quantum-well semiconductor.

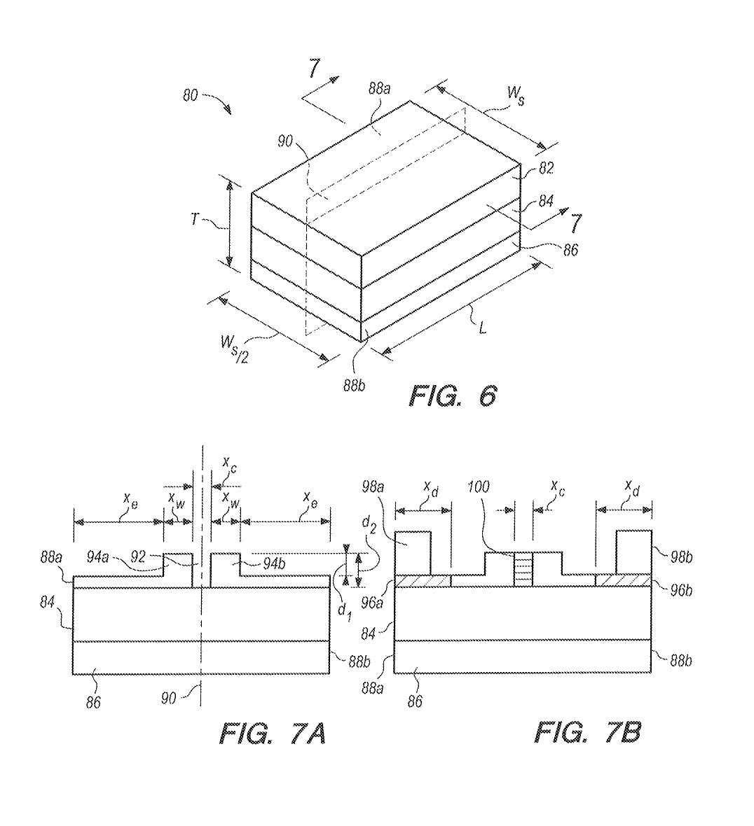

Referring now to FIG. 6, a method for manufacturing an electro-optically coupled switch in accordance with the present invention is disclosed. In FIG. 6 it will be appreciated that the method first requires providing a base member that has been generally designated 80. As shown, the base member 80 includes a layer 82 of a semiconductor material. Also, the base member 80 includes a layer 84 of an insulator material that is positioned between the semiconductor layer 82 and a substrate 86 that is also made of a semiconductor material. For purposes of the present invention, the semiconductor material that is used for the layer 82 may be of any type well known in the pertinent art, such as silicon, or compound semiconductors such as InP, GaAs, GaN, or a quantum well composition of various compound semiconductors.

When constructed, the base member 80 will have a length L, a width Wₛ and a thickness T. The base member 80 will also have opposite edges 88a and 88b which straddle the central plane 90 that is defined by the base member 80.

As an overview of the methodology for the present invention, FIG. 7A shows that the semiconductor layer 82 is to be reconfigured to form a slot 92 which is positioned along the central plane 90 between opposed waveguides 94a and 94b. Note: the depth of the slot 92 extends through the semiconductor layer 82 to expose the layer 84 of insulator material. Still referring to FIG. 7A it will be appreciated that the slot 92 will have a width x_{c} along the length L of the slot 92, and that the waveguides 94a and 94b each have an operational width x_{w} adjacent the slot 92, as well as an extension of width xₑ that extends from the waveguides 94a and 94b toward the edges 88a and 88b of the base member 80.

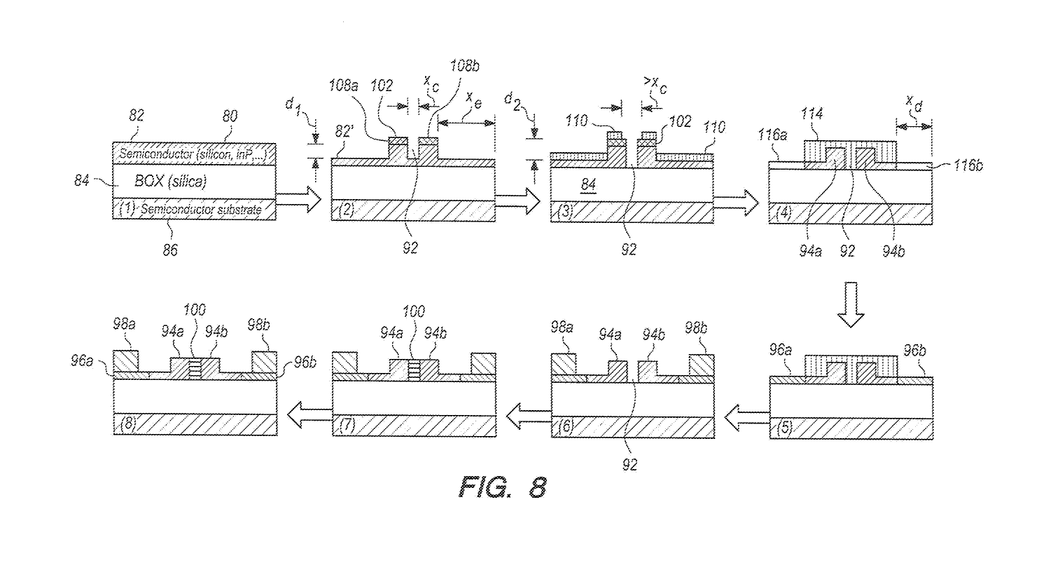

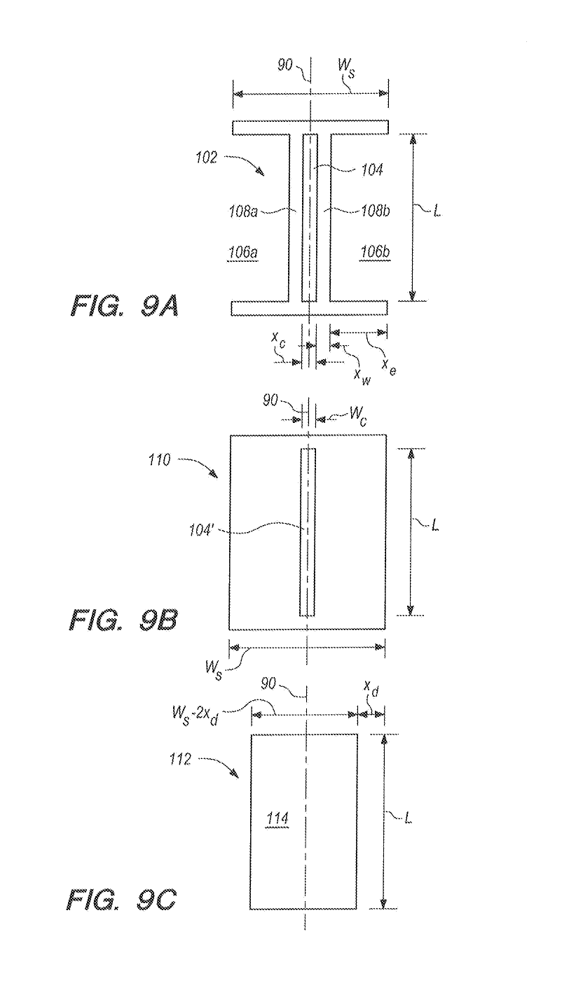

FIG. 7B shows that the semiconductor layer 82 will be further reconfigured to form contact pads 96a and 96b at the edges 88a and 88b of the base member 80. Additionally, metal electrodes 98a and 98b are then to be positioned in electrical contact with the respective contact pads 96a and 96b. Further, FIG. 7B shows that the slot 92 is filled with a cross-coupling material 100. For purposes of the present invention, the cross-coupling material 100 can be of any type material known in the pertinent art for the specified purposes of the present invention. Preferably, the cross-coupling material 100 will be a polymer. With the above overview in mind, the methodology of the present invention is best appreciated with reference to FIG. 8 and FIGS. 9A, 9B and 9C.

FIG. 8 shows that the method for manufacturing an electro-optically coupled switch is essentially an eight step process. In FIG. 8, these steps are designated sequentially as (1), (2), (3) . . . (8). To begin, as shown in FIG. 8(1), a base member 80 is constructed as disclosed above. Then, a first mask 102 is positioned on the layer 82 of semiconductor material and it is aligned on the layer 82 relative to the central plane 90 substantially as shown in FIG. 9A. As best seen in FIG. 9A, the first mask 102 is formed with a central cutout 104 and a pair of side cutouts 106a and 106b. Between the central cutout 104 and the side cutouts 106a and 106b are two parallel strips 108a and 108b that are separated from each other by the distance x_{c}. With the first mask 102 in position on the layer 82, FIG. 8(2) shows that, in a first etch, the semiconductor material in the layer 82 is etched to a depth of d₁. The result here is to create a reconfigured layer 82′ that is formed with the slot 92.

FIG. 8(3) shows that after the first etch, a second mask 110 is positioned over the first mask 102. FIG. 9B shows that this second mask 110 is formed with only a central cutout 104′. For purposes of the present invention, this central cutout 104′ can be formed with a width W_{c} where x_{c}<W_{c}<x_{c}+2x_{w}. In any event, the second mask 110 is intended to mask the entire layer 82′ with the exception of the slot 92. Accordingly, in a second etch, with the second mask 110 in place, the layer 82′ of semiconductor material can be further reconfigured. Specifically, as shown in FIG. 8(3), semiconductor material in the slot 92 can be removed through the depth d₂ to expose insulator material in the layer 84. The second mask 110 and the first mask 102 can then be removed.

In the next sequential step, FIG. 8(4) shows that a third mask 112 is positioned over the layer 82 of semiconductor material to cover the slot 92 and portions of the waveguides 94a and 94b. For the present invention, the third mask 112 is essentially a solid panel 114 (See FIG. 9C). This effectively exposes the edge segments 116a and 116b shown in FIG. 8(4). Thus, semiconductor material in the edge segments 116a and 116b of layer 82 can be heavily doped in this process. As shown in FIG. 8(5), after the doping of edge segments 116a and 116b, the respective contact pads 96a and 96b can be formed. As noted above, the contact pads 96a and 96b are preferably formed by N⁺ doped semiconductor material.

With the above in mind, it follows as shown in FIG. 8(6) that metal electrodes 98a and 98b can be positioned on respective contact pads 96a and 96b. FIG. 8(7) then indicates that the next step in the methodology is to fill the slot 92 with a cross-coupling material 100, such as an electro-optical polymer. A final step, which is appreciated with reference to FIG. 8(8), is that the cross-coupling material 100 (i.e. electro-optical polymer) can be poled in the slot 92 to optimize its electro-magnetic coefficient for cross-coupling optical signals as they pass through the waveguides 94a and 94b.

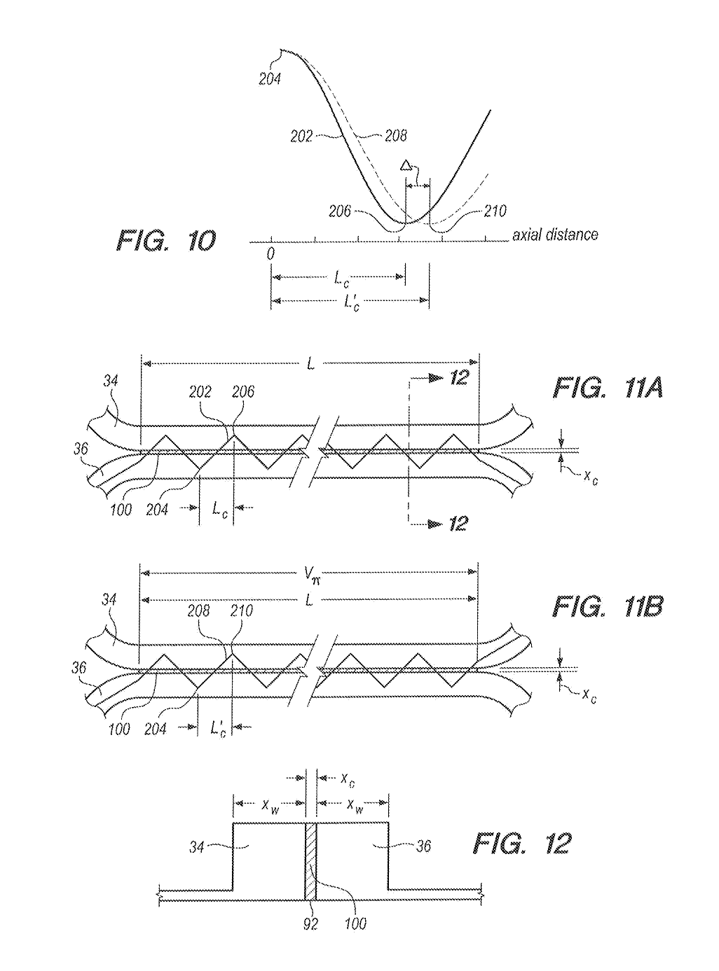

In another aspect of the present invention, the modulation for switching an optical signal from one waveguide to another is accomplished by electro-optically changing the cross-coupling length of path 202 for the optical signal. With reference to FIG. 10, several considerations for the switching function provided by this aspect of the invention are presented.

To disclose the switching function mentioned above, FIG. 10 is presented to point out prominent characteristics of the cross-coupling path 202 that is followed by an unmodulated optical signal through the optical switch 10. In FIG. 10, these characteristics are shown in the context of a cross-coupling length (L_{c}) cycle of the optical signal. As shown, the cycle begins at a start point 204 and continues to an end point 206. At the end point 206 the optical signal changes direction to start the next cycle. Note that in each cycle the optical signal will pass through the cross-coupling material 100 (see FIG. 11A), and for each cycle the path 202 will have an unmodulated cross-coupling length L_{c}.

Still referring to FIG. 10, it is to be appreciated that under the influence of a switching voltage V_{π} the optical signal will be modulated to follow a modulated optical path 208 (see also FIG. 11B). For purposes of comparison, the modulated optical path 208 is shown in FIG. 10 to begin at the same start point 204, but it will have a different end point 210. Specifically, the difference between end point 206 of the unmodulated path 202 and the end point 210 of the modulated path 208 is an incremental change Δ that is caused by the switching voltage V_{π}. As envisioned for the present invention, V_{π} can be measured from a zero voltage or from a V_{base}. In the latter case, V_{base} can be established to compensate for fabrication and operational variations. The consequence here is that the unmodulated cross-coupling length L_{c} on path 202 changes to a modulated cross-coupling length L_{c}′ on path 208. It is important here to note that, depending on the direction of the electric field E, the incremental change Δ shown in FIG. 10 may be either ±. Accordingly, L_{c}=L_{c}′±Δ.

An important feature of the present invention is that as a modulated optical signal switches back and forth through the cross-coupling material 100 on path 208, the incremental changes Δ are cumulative. Thus, it will happen after switching occurs through an N number of cross-coupling lengths, i.e. an N number of cycles, the optical signal will have traveled along a length L of the cross-coupling material 100, and NΔ will equal L_{c}′. Thus, the modulated cross-coupling length L_{c}′=NΔ and L=NL_{c}=(N±1)L_{c}′. Furthermore, as an approximation L_{c}=L_{c}′, and in reality L_{c} and L_{c}′>>Δ.

Another important feature of the present invention, as shown in FIG. 12, is that the slot 92 between the waveguide-electrodes 34 and 36 will have a separation distance x_{c} that establishes a confinement factor Γ for the cross-coupling material 100. Specifically, the confinement factor Γ, which is a measure of the optical signal intensity confined in the slot when passing through the cross-coupling material 100, will preferably be greater than 0.15 when x_{c} is less than 0.35 μm. Preferably, x_{c} will be less than 0.35 μm and remain essentially within a range between 0.4 μm and 0.04 μm along the common length L of the slot between the waveguide-electrodes. The purpose here is to create a modulated cross-coupling length L_{c}′ that is less than approximately 2λ under the influence of V_{π} (i.e. Γ>0.15, when x_{c}<0.35 μm, to achieve L_{c}′<2λ).

With the above in mind, the length L of the cross-coupling material 100 (i.e. the length of slot 92) is established such that the path 202 of the optical signal entering the optical switch 10 will be changed (shorter or longer), during its transit on the path 208 along the length L, by a length that is less than 2λ. After the optical signal has traveled the length L between the waveguide-electrodes 34, 36, the present invention recognizes that the waveguide-electrodes 34, 36 can be separated from each other, and the optical signal will be effectively switched from one waveguide-electrode 34, 36 to the other. As disclosed above, from a structural perspective it is to be appreciated that the width x_{c} of the slot 92 may vary slightly along the common length L between the waveguide-electrodes 34 and 36. It is also to be appreciated that the orientation between the waveguide-electrodes 34 and 36 may not be absolutely parallel with each other. Indeed, it may be desirable to have a slight divergence between the waveguide-electrodes 34 and 36 at the end of the common length L where the optical signal is switched from one waveguide-electrode (34 or 36) to the other waveguide-electrode (36 or 34).

While the particular Optical Modulator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An optical modulator for switching an optical signal of wavelength λ between two waveguides, which comprises:
a first waveguide-electrode made of an electrically conductive material and having an input port and an output port with a length L therebetween;
a second waveguide-electrode made of an electrically conductive material and having an input port and an output port, wherein the first waveguide-electrode and the second waveguide-electrode are oriented in a side-by-side alignment along the length L;
a non-conducting cross-coupling material positioned between the first waveguide-electrode and the second waveguide-electrode along the length L to establish a slot having a separation distance x_{c} therebetween, wherein x_{c} is less than 0.35 microns to establish a cross-coupling length L_{c} for the optical signal during transit through the cross-coupling material from one waveguide-electrode to the other, wherein L_{c} approaches the wavelength λ; and
a voltage source electrically connected to the first waveguide-electrode and to the second waveguide-electrode to selectively apply a switching voltage V_{π} therebetween for creating a strong, uniform electric field E confined within the cross-coupling material along the length L, to modulate the cross-coupling length L_{c} by an increment Δ, to establish a modulated cross-coupling length L_{c}′(L′=L_{c}±Δ) for switching the optical signal from one waveguide-electrode to the other, wherein switching occurs after an N number of cross-coupling length cycles of the optical signal along the length L in the waveguide-electrodes, when L_{c}′=NΔ, and L=NL_{c}=(N±1)L_{c}′.

2. The optical modulator recited in claim 1 wherein L is in a range between 0.5 mm and 5 mm.

3. The optical modulator recited in claim 1 wherein L is in a range between 0.5 μm and 5 μm.

4. The optical modulator recited in claim 1 wherein no switching occurs when the voltage source applies a voltage V_{base}, and causes switching when an applied voltage from the voltage source equals V_{base}+V_{π}.

5. The optical modulator recited in claim 4 wherein V_{base}=0.

6. The optical modulator recited in claim 1 wherein the first waveguide-electrode and the second waveguide-electrode are made of a conducting semiconductor material.

7. The optical modulator recited in claim 1 wherein the non-conducting cross-coupling material is a polymer and has an index of refraction n, wherein n is a function of an electro-optical index modulation coefficient r modulated by V_{π}, with r greater than 20 pm/V.

8. The optical modulator recited in claim 1 wherein the cross-coupling material in the slot establishes an optical slot confinement factor Γ, wherein the confinement factor Γ is greater than 0.15 when x_{c} is less than 0.35 μm, to create a modulated cross-coupling length L_{c}′ less than 2λ under the influence of V_{π} (Γ>0.15, when x_{c}<0.35 μm, to achieve L_{c}′<2λ).

9. The optical modulator recited in claim 1 wherein the length L of the slot is determined relative to the modulation increment Δ created by the switching voltage V_{π} to establish a relationship wherein L=NL_{c}=(N±1)L_{c}′.

10. A method for manufacturing an optical modulator for switching an optical signal between two waveguides, wherein the optical signal has a wavelength λ and follows a wave path through the optical modulator, the method comprising the steps of:
providing a non-conducting cross-coupling material, a first waveguide-electrode and a second waveguide-electrode, wherein each waveguide-electrode is made of an electrically conductive material and has an input port and an output port with a length L therebetween;
orienting the first waveguide-electrode to the second waveguide-electrode in a side-by-side alignment to create a slot therebetween along the length L, wherein the slot has a separation distance x_{c} between the first and second waveguide-electrodes, and x_{c} is less than 0.35 microns; and
filling the slot between the first waveguide-electrode and the second waveguide-electrode with the non-conducting cross-coupling material along the length L to establish an optical slot confinement factor Γ in the slot wherein, when a switching voltage V_{π} is applied between the first and second waveguide-electrodes, the confinement factor Γ is greater than 0.15 to create a cross-coupling length L_{c} less than 2λ for the optical signal during transit through the cross-coupling material from one waveguide-electrode to the other (Γ>0.15, when x_{c}<0.35 μm, to achieve L_{c}′<2λ).

11. The method recited in claim 10 further comprising the step of connecting a voltage source to the first waveguide-electrode and to the second waveguide-electrode to selectively apply the switching voltage V_{π} therebetween for creating a strong, uniform electric field E confined within the cross-coupling material along the length L, to modulate the cross-coupling length L_{c} of the optical signal by an increment Δ and establish a modulated cross-coupling length L_{c}′(L_{c}′=L_{c}±Δ), wherein after an N number of cross-coupling length cycles of the optical signal along the length L in the waveguide-electrodes, when L=NL_{c}=NL_{c}′±NΔ and L_{c}′=NΔ, the optical signal is switched from one waveguide-electrode to the other.

12. The method recited in claim 11 wherein the length L of the slot is determined relative to the modulation increment Δ created by the switching voltage V_{π} to establish a relationship wherein L=NL_{c}=(N±1)L_{c}′.

13. The method recited in claim 12 wherein L_{c} is in a range between 0.5 μm and 5 μm.

14. The method recited in claim 12 wherein L is in a range between 0.5 mm and 5 mm.

15. A method for manufacturing an optical modulator for switching an optical signal between two waveguides, wherein the optical signal has a wavelength λ and follows a wave path through the optical modulator, the method comprising the steps of:
providing a non-conducting cross-coupling material, a first waveguide-electrode and a second waveguide-electrode, wherein each waveguide-electrode is made of an electrically conductive material and has an input port and an output port with a length L therebetween;
orienting the first waveguide-electrode parallel to the second waveguide-electrode in a side-by-side alignment to create a slot therebetween along the length L, wherein the slot has a separation distance x_{c} between the first and second waveguide-electrodes, and x_{c} is less than 0.35 microns; and
filling the slot between the first waveguide-electrode and the second waveguide-electrode with the non-conducting cross-coupling material along the length L, wherein the length L is established for a requirement that the wave path of the optical signal be changed by a length less than 2λ during transit of the optical signal along the length L.

16. The method recited in claim 15 wherein the orienting step establishes an optical slot confinement factor Γ in the slot wherein, when a switching voltage V_{π} is applied between the first and second waveguide-electrodes, the confinement factor Γ is greater than 0.15 to create a cross-coupling length L_{c} less than 2λ for the optical signal during transit through the cross-coupling material from one waveguide-electrode to the other (Γ>0.15, when x_{c}<0.35 μm, to achieve L_{c}′<2λ).

17. The method recited in claim 15 further comprising the step of connecting a voltage source to the first waveguide-electrode and to the second waveguide-electrode to selectively apply the switching voltage V_{π} therebetween for creating a strong, uniform electric field E confined within the cross-coupling material along the length L, to modulate the unmodulated cross-coupling length L_{c} of the optical signal by an increment Δ and establish a modulated cross-coupling length L_{c}′(L_{c}′=L_{c}±Δ), wherein after an N number of cross-coupling length π cycles of the optical signal along the length L in the waveguide-electrodes, when L=NL_{c}=NL_{c}′±NΔ and L_{c}′=NΔ, the optical signal is switched from one waveguide-electrode to the other.

18. The method recited in claim 15 wherein L_{c} is in a range between 0.5 μm and 5 μm.

19. The method recited in claim 15 wherein L is in a range between 0.5 mm and 5 mm.

20. The method recited in claim 15 wherein the first and second waveguides are made of a conducting semiconductor material.
